(19) United States
(12) Patent Application Publication
(10) Pub. No.: US 2022/0064372 A1
(43) Pub. Date: Mar. 3, 2022

(54) POLYCARBONATE POLYOL AND USES OF THE SAME

(71) Applicant: Dairen Chemical Corporation, Taipei City (TW)

(72) Inventors: Wei-Lun HSIEH, Taipei City (TW); Hsing-Yun WANG, Taipei City (TW)

(21) Appl. No.: 17/459,261

(22) Filed: Aug. 27, 2021

(30) Foreign Application Priority Data
Aug. 28, 2020 (TW) 109129641

(51) Int. Cl. C08G 64/02

(52) U.S. Cl. CPC C08G 64/0208

(57) ABSTRACT

A polycarbonate polyol is provided. The polycarbonate polyol comprises a repeating unit represented by the following formula (I) and terminal hydroxyls:

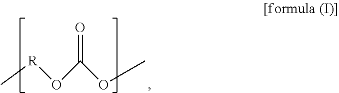

in formula (I), R is a substituted or unsubstituted C₂-C₂₀ divalent aliphatic hydrocarbyl, wherein the ¹H-NMR spectrum of the polycarbonate polyol has an integral value A of signals from 4.00 ppm to 4.50 ppm and an integral value D of signals from 0.90 ppm to 1.10 ppm, the ratio of D to A (D/A) ranges from 0.03 to 1.45, and the ¹H-NMR spectrum is measured by using deuterated chloroform as a solvent and tetramethylsilane as a reference substance.

### CLAIM FOR PRIORITY

This application claims the benefit of Taiwan Patent Application No. 109129641 filed on Aug. 28, 2020, the subject matters of which are incorporated herein in their entirety by reference.

### BACKGROUND OF THE INVENTION

### Field of the Invention

The present application provides a polycarbonate polyol, in particular, it is a polycarbonate diol. The present application also provides an elastomer precursor composition and an elastomer that are provided by using the polycarbonate polyol.

### Descriptions of the Related Art

Polycarbonate polyol is a material with good hydrolysis resistance, light resistance, oxidization degeneration resistance, and thermal resistance. Polycarbonate polyol is useful for preparing elastomers, paints, coating materials or adhesive agents. In the preparation of elastomers, a specific branched-chain alcohol can be incorporated into the polycarbonate polyol to increase the transmittance of the elastomer prepared from the polycarbonate polyol. However, the incorporation of the branched-chain alcohol will decrease the mechanical strength of the elastomer, such that the elastomer will not be able to prepare products requiring high mechanical strength (e.g., sporting equipment).

Thus, there is still a need for a polycarbonate polyol that can be used to prepare an elastomer comprising high mechanical strength, high wear resistance, and high transmittance concurrently.

### SUMMARY OF THE INVENTION

The present application provides a polycarbonate polyol, an elastomer precursor composition provided by using the polycarbonate polyol, and an elastomer prepared by using the elastomer precursor composition. The problem being solved by the present application is that conventional polycarbonate polyols cannot provide an elastomer with concurrent high mechanical strength, high wear resistance, and high transmittance. The technical means of the present application is to use a polycarbonate polyol satisfying these specific conditions, thereby significantly improving the mechanical strength and wear resistance of an elastomer prepared from the polycarbonate polyol without affecting the transmittance of the elastomer. Thus, the present application involves the following inventive objectives.

An objective of the present application is to provide a polycarbonate polyol, which comprises a repeating unit represented by the following formula (I) and terminal hydroxyls:

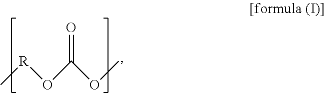

in formula (I), R is a substituted or unsubstituted C₂-C₂₀ divalent aliphatic hydrocarbyl, wherein the ¹H-NMR spectrum of the poly carbonate polyol has an integral value A of signals from 4.00 ppm to 4.50 ppm and an integral value D of signals from 0.90 ppm to 1.10 ppm, the ratio of D to A (D/A) ranges from 0.03 to 1.45, and the ¹H-NMR spectrum is measured by using deuterated chloroform as a solvent and tetramethylsilane as a reference substance.

In some embodiments of the present application, the ¹H-NMR spectrum is obtained by using a nuclear magnetic resonance spectrometer to measure the polycarbonate polyol under the following conditions: a resonance frequency of 600 MHZ, a pulse width of 45°, an acquisition time of 1 (one) second, a number of scan of 128, and a signal of tetramethylsilane being set to 0 ppm.

In some embodiments of the present application, the ratio of D to A (D/A) ranges from 0.10 to 1.40.

In some embodiments of the present application, the ¹H-NMR spectrum of the polycarbonate polyol has an integral value F of signals from 3.70 ppm to 3.85 ppm, and the ratio of F to A (F/A) is not larger than 0.01.

In some embodiments of the present application, the repeating unit represented by formula (I) comprises at least one of a repeating unit represented by the following formula (I-1), a repeating unit represented by the following formula (I-2), and a repeating unit represented by the following formula (I-3),

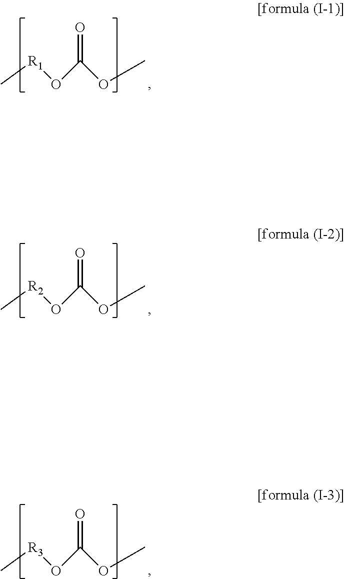

wherein, R₁ is a C₂-C₁₂ linear divalent aliphatic hydrocarbyl, R₂ is a C₄-C₁₂ divalent aliphatic hydrocarbyl with a tertiary carbon atom and without a quaternary carbon atom, and R₃ is C₅-C₁₂ divalent aliphatic hydrocarbyl with a quaternary carbon atom.

In some embodiments of the present application, the polycarbonate polyol comprises at least one of the repeating unit represented by formula (I-2) and the repeating unit represented by formula (I-3).

In some embodiments of the present application, the polycarbonate polyol further comprises the repeating unit represented by formula (I-1).

In some embodiments of the present application, R₁ in formula (I-1) is a C₃-C₁₀ linear divalent aliphatic hydrocarbyl, R₂ in formula (I-2) is a C₄-C₁₀ divalent aliphatic hydrocarbyl with a tertiary carbon atom and without a quaternary carbon atom, and R₃ in formula (I-3) is C₅-C₁₀ divalent aliphatic hydrocarbyl with a quaternary carbon atom.

Another objective of the present application is to provide an elastomer precursor composition, which comprises the aforementioned polycarbonate polyol, and an optional chain extending agent.

Yet another objective of the present application is to provide an elastomer, which is prepared from the aforementioned elastomer precursor composition.

To render the above objectives, technical features and advantages of the present application more apparent, the present application will be described in detail with reference to some embodiments hereinafter.

### BRIEF DESCRIPTION OF THE DRAWINGS

Not applicable.

### DESCRIPTION OF THE PREFERRED EMBODIMENTS

Hereinafter, some embodiments of the present application will be described in detail. However, without departing from the spirit of the present application, the present application may be embodied in various embodiments and should not be limited to the embodiments described in the specification.

Unless it is additionally explained, the expressions “a,” “the,” or the like recited in the specification and the claims should include both the singular and the plural forms.

As used herein, the term “tertiary carbon atom” refers to a carbon atom that bonds to three carbon atoms, and the term “quaternary carbon atom” refers to a carbon atom that bonds to four carbon atoms.

As used herein, “¹H-NMR (proton nuclear magnetic resonance) spectrum” is a spectrum obtained by using deuterated chloroform as a solvent and tetramethylsilane as a reference substance, wherein the signal of tetramethylsilane is set as the start point of the spectrum (0 ppm).

As used herein, the term “terminal hydroxyl” refers to a hydroxyl (—OH) that connects to a terminal of a polymer main chain.

### 1. POLYCARBONATE POLYOL

The present application provides a polycarbonate polyol, which can be used to provide an elastomer simultaneously comprising wear resistance, high mechanical strength and high transmittance. In some embodiments of the present application, a polycarbonate diol is provided.

1.1. Property of Polycarbonate Polyol

The polycarbonate polyol of the present application has the following features: the ¹H-NMR spectrum of the polycarbonate polyol has an integral value A of signals from 4.00 ppm to 4.50 ppm and an integral value D of signals from 0.90 ppm to 1.10 ppm, and the ratio of the integral value D to the integral value A (D/A) ranges from 0.03 to 1.45. In some embodiments of the present application, the ratio of the integral value D to the integral value A (D/A) ranges from 0.10 to 1.45. For example, the ratio of the integral value D to the integral value A (D/A) can be 0.11, 0.12, 0.13, 0.14, 0.15, 0.16, 0.17, 0.18, 0.19, 0.20, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, 0.40, 0.41, 0.42, 0.43, 0.44, 0.45, 0.46, 0.47, 0.48, 0.49, 0.50, 0.51, 0.52, 0.53, 0.54, 0.55, 0.56, 0.57, 0.58, 0.59, 0.60, 0.61, 0.62, 0.63, 0.64, 0.65, 0.66, 0.67, 0.68, 0.69, 0.70, 0.71, 0.72, 0.73, 0.74, 0.75, 0.76, 0.77, 0.78, 0.79, 0.80, 0.81, 0.82, 0.83, 0.84, 0.86, 0.86, 0.87, 0.88, 0.89, 0.90, 0.91, 0.92, 0.93, 0.94, 0.95, 0.96, 0.97, 0.98, 0.99, 1.00, 1.01, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.20, 1.21, 1.22, 1.23, 1.24, 1.25, 1.26, 1.27, 1.28, 1.29, 1.30, 1.31, 1.32, 1.33, 1.34, 1.35, 1.36, 1.37, 1.38, 1.39, 1.40, 1.41, 1.42, 1.43, or 1.44, or within a range between any two of the values described herein. When the D/A value of the polycarbonate polyol is within the designated range of the present application, the elastomer prepared therefrom can be provided with better transmittance and mechanical strength.

The ¹H-NMR spectrum of the polycarbonate polyol of the present application is obtained by using a nuclear magnetic resonance spectrometer to measure the polycarbonate polyol, wherein deuterated chloroform is used as a solvent and tetramethylsilane is used as a reference substance. More particularly, the ¹H-NMR spectrum of the polycarbonate polyol of the present application is obtained by using a nuclear magnetic resonance spectrometer to measure the polycarbonate polyol under the following conditions: a resonance frequency of 600 MHZ, a pulse width of 45°, an acquisition time of 1 (one) second, a number of scan of 128, and a signal of tetramethylsilane being set to 0 ppm.

In some embodiments of the present application, the ¹H-NMR spectrum of the polycarbonate polyol has an integral value F of signals from 3.70 ppm to 3.85 ppm, and the ratio of the integral value F to the integral value A (F/A) is not higher than 0.01, such as not higher than 0.0099, not higher than 0.0098, or not higher than 0.0097. When the F/A value of the polycarbonate polyol is within the designated range of the present application, the elastomer prepared therefrom can be provided with better tensile strength.

1.2. Structure of Polycarbonate Polyol

The polycarbonate polyol of the present application comprises a repeating unit represented by the following formula (I) and terminal hydroxyls, wherein in formula (I), R is a substituted or unsubstituted C₂-C₂₀ divalent aliphatic hydrocarbyl.

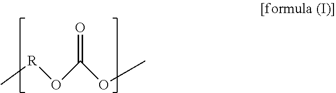

Examples of the C₂-C₂₀ divalent aliphatic hydrocarbyl include but are not limited to a C₂-C₂₀ alkylene, a C₂-C₂₀ alkenediyl, and a C₂-C₂₀ alkynediyl.

Examples of the C₂-C₂₀ alkylene include but are not limited to ethylene, propylene, butylene, pentylene, hexylene, heptylene, octylene, nonylene, decylene, undecylene, dodecylene, tridecylene, tetradecylene, pentadecylene, hexadecylene, heptadecylene, octadecylene, nonadecylene, eicosylene, isopropylene, isobutylene, sec-butylene, tert-butylene, isopentylene, neo-pentylene, tert-pentylene, isohexylene, isoheptylene, isooctylene, isononylene, isodecylene, isoundecylene, isododecylene, isotridecylene, isotetradecylene, isopentadecylene, isohexadecylene, isoheptadecylene, isooctadecylene, isononadecylene, isoeicosylene, 1-methyl-1-ethylpropylene, 2-methyl-2-ethylpropylene, 2,2-dimethylbutylene, 2-methylpentylene, 3-methylpentylene, 2,2-diethylpropylene, 1-methyl-1-propylpropylene, 2-methyl-2-propylpropylene, 1-methyl-1-ethylbutylene, 2-methyl-2-ethylbutylene, 2,2-dimethylpentylene, 3,3-dimethylpentylene, 2,3-dimethylpentylene, 1-ethylpentylene, 2-ethylpentylene, 3-ethylpentylene, 2-methylhexylene, 3-methylhexylene, 1-methyl-1-butylpropylene, 2-methyl-2-butylpropylene, 1-methyl-2-butylpropylene, 1-butyl-2-methylpropylene, 1-ethyl-1-propylpropylene, 2-ethyl-2-propylpropylene, 1-ethyl-2-propylpropylene, 1-propyl-2-ethylpropylene, 1,1-diethylbutylene, 2,2-diethylbutylene, 1,2-diethylbutylene, 1-methyl-1-propylbutylene, 2-methyl-2-propylbutylene, 1-methyl-2-propylbutylene, 1-propyl-2-methylbutylene, 1-propylpentylene, 2-propylpentylene, 3-propylpentylene, 2,2-dimethylhexylene, 3,3-dimethylhexylene, 2,3-dimethylhexylene, 2,4-dimethylhexylene, 1-ethylhexylene, 2-ethylhexylene, 3-ethylhexylene, 1-ethyl-1-butylpropylene, 2-ethyl-2-butylpropylene, 1-ethyl-2-butylpropylene, 1-butyl-2-ethylpropylene, 1-ethyl-1-propylbutylene, 2-ethyl-2-propylbutylene, 1-ethyl-2-propylbutylene, 1-propyl-2-ethylbutylene, 1-ethyl-3-propylbutylene, 1-propyl-3-ethylbutylene, 2-ethyl-3-propylbutylene, 1-methyl-1-butylbutylene, 2-methyl-2-butylbutylene, 1-methyl-2-butylbutylene, 1-butyl-2-methylbutylene, 1-methyl-3-butylbutylene, 1-butyl-3-methylbutylene, 1-butylpentylene, 2-butylpentylene, 3-butylpentylene, 1,1-diethylpentylene, 2,2-diethylpentylene, 3,3-diethylpentylene, 1,2-diethylpentylene, 1,3-diethylpentylene, 2,3-diethylpentylene, 2,4-diethylpentylene, 1-propylhexylene, 2-propylhexylene, 3-propylhexylene, 1-methyl-1-ethylhexylene, 2-methyl-2-ethylhexylene, 3-methyl-3-ethylhexylene, 1-methyl-2-ethylhexylene, 1-methyl-3-ethylhexylene, 2-methyl-3-ethylhexylene, 1-ethylheptylene, 2-ethylheptylene, 3-ethylheptylene, and 4-ethylheptylene.

Examples of the C₂-C₂₀ alkenediyl include but are not limited to vinylene, vinylidene, propene-1,2-diyl, propene-1,3-diyl, butene-1,2-diyl, butene-1,3-diyl, butene-1,4-diyl, pentene-1,2-diyl, pentene-1 ,3-diyl, pentene-1,4-diyl, pentene-1,5-diyl, hexene-1,2-diyl, hexene-1,3-diyl, hexene-1,4-diyl, hexene-1,5-diyl, hexene-1,6-diyl, heptene-1,2-diyl, heptene-1,3-diyl, heptene-1,4-diyl, heptene-1,5-diyl, heptene-1,6-diyl, heptene-1,7-diyl, octene-1,2-diyl, octene-1,3-diyl, octene-1,4-diyl, octene-1,5-diyl, octene-1,6-diyl, octene-1,7-diyl, octene-1,8-diyl, nonene-1,2-diyl, nonene-1,3-diyl, nonene-1,4-diyl, nonene-1,5-diyl, nonene-1,6-diyl, nonene-1,7-diyl, nonene-1,8-diyl, nonene-1,9-diyl, decene-1,2-diyl, decene-1,3-diyl, decene-1,4-diyl, decene-1,5-diyl, decene-1,6-diyl, decene-1,7-diyl, decene-1,8-diyl, decene-1,9-diyl, and decene-1,10-diyl.

Examples of the C₂-C₂₀ alkynediyl include but are not limited to ethylnylene, propyne-1,2-diyl, propyne-1,3-diyl, butyne-1,2-diyl, butyne-1,3-diyl, butyne-1,4-diyl, pentyne-1,2-diyl, pentyne-1,3-diyl, pentyne-1,4-diyl, pentyne-1,5-diyl, hexyne-1,2-diyl, hexyne-1,3-diyl, hexyne-1,4-diyl, hexyne-1,5-diyl, hexyne-1,6-diyl, heptyne-1,2-diyl, heptyne-1,3-diyl, heptyne-1,4-diyl, heptyne-1,5-diyl, heptyne-1,6-diyl, heptyne-1,7-diyl, octyne-1,2-diyl, octyne-1,3-diyl, octyne-1,4-diyl, octyne-1,5-diyl, octyne-1,6-diyl, octyne-1,7-diyl, octyne-1,8-diyl, nonyne-1,2-diyl, nonyne-1,3-diyl, nonyne-1,4-diyl, nonyne-1,5-diyl, nonyne-1,6-diyl, nonyne-1,7-diyl, nonyne-1,8-diyl, nonyne-1,9-diyl, decyne-1,2-diyl, decyne-1,3-diyl, decyne-1,4-diyl, decyne-1,5-diyl, decyne-1,6-diyl, decyne-1,7-diyl, decyne-1,8-diyl, decyne-1,9-diyl, and decyne-1,10-diyl.

In some embodiments of the present application, the repeating unit represented by formula (I) comprises at least one of a repeating unit represented by the following formula (I-1), a repeating unit represented by the following formula (I-2), and a repeating unit represented by the following formula (I-3).

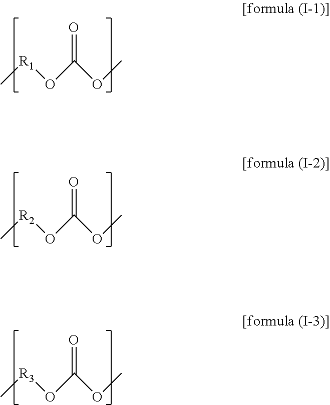

In formulas (I-1) to (I-3), R₁ is a C₂-C₁₂ linear divalent aliphatic hydrocarbyl, R₂ is a C₄-C₁₂ divalent aliphatic hydrocarbyl with a tertiary carbon atom and without a quaternary carbon atom, and R₃ is a C₅-C₁₂ divalent aliphatic hydrocarbyl with a quaternary carbon atom. In a preferred embodiment of the present application, R₁ is a C₃-C₁₀ linear divalent aliphatic hydrocarbyl, R₂ is a C₄-C₁₀ divalent aliphatic hydrocarbyl with a tertiary carbon atom and without a quaternary carbon atom, and R₃ is a C₅-C₁₀ divalent aliphatic hydrocarbyl with a quaternary carbon atom.

Examples of the C₂-C₁₂ linear divalent aliphatic hydrocarbyl include but are not limited to ethylene, propylene, butylene, pentylene, hexylene, heptylene, octylene, nonylene, decylene, undecylene, dodecylene, vinylene, propene-1,3-diyl, butene-1,4-diyl, pentene-1,5-diyl, hexene-1,6-diyl, heptene-1,7-diyl, octene-1,8-diyl, nonene-1,9-diyl, decene-1,10-diyl, propyne-1,3-diyl, butyne-1,4-diyl, pentyne-1,5-diyl, hexyne-1,6-diyl, heptyne-1,7-diyl, octyne-1,8-diyl, nonyne-1,9-diyl, and decyne-1,10-diyl.

Examples of the C₄-C₁₂ divalent aliphatic hydrocarbyl with a tertiary carbon atom and without a quaternary carbon atom include but are not limited to isopropylene, isobutylene, sec-butylene, isohexylene, isoheptylene, isooctylene, isononylene, isodecylene, isoundecylene, isododecylene, 2-methylpentylene, 3-methylpentylene, 1-ethylpentylene, 2-ethylpentylene, 3-ethylpentylene, 2-methylhexylene, 3-methylhexylene, 1-propylpentylene, 2-propylpentylene, 3-propylpentylene, 1-ethylhexylene, 2-ethylhexylene, 3-ethylhexylene, 1-butylpentylene, 2-butylpentylene, 3-butylpentylene, 1-propylhexylene, 2-propylhexylene, 3-propylhexylene, 1-ethylheptylene, 2-ethylheptylene, 3-ethylheptylene, and 4-ethylheptylene.

Examples of the C₅-C₁₂ divalent aliphatic hydrocarbyl with a quaternary carbon atom include but are not limited to tert-butylene, neo-pentylene, tert-pentylene, 1-methyl-1-ethylpropylene, 2-methyl-2-ethylpropylene, 2,2-diethylpropylene, 1-methyl-1-propylpropylene, 2-methyl-2-propylpropylene, 1-methyl-1-ethylbutylene, 2-methyl-2-ethylbutylene, 2,2-dimethylpentylene, 3,3-dimethylpentylene, 2,3-dimethylpentylene, 1-methyl-1-butylpropylene, 2-methyl-2-butylpropylene, 1-methyl-2-butylpropylene, 1-butyl-2-methylpropylene, 1-ethyl-1-propylpropylene, 2-ethyl-2-propylpropylene, 1-ethyl-2-propylpropylene, 1-propyl-2-ethylpropylene, 1,1-diethylbutylene, 2,2-diethylbutylene, 1,2-diethylbutylene, 1-methyl-1-propylbutylene, 2-methyl-2-propylbutylene, 1-methyl-2-propylbutylene, 1-propyl-2-methylbutylene, 2,2-dimethylhexylene, 3,3-dimethylhexylene, 2,3-dimethylhexylene, 2,4-dimethylhexylene, 1-ethyl-1-butylpropylene, 2-ethyl-2-butylpropylene, 1-ethyl-2-butylpropylene, 1-butyl-2-ethylpropylene, 1-ethyl-1-propylbutylene, 2-ethyl-2-propylbutylene, 1-ethyl-2-propylbutylene, 1-propyl-2-ethylbutylene, 1-ethyl-3-propylbutylene, 1-propyl-3-ethylbutylene, 2-ethyl-3-propylbutylene, 1-methyl-1-butylbutylene, 2-methyl-2-butylbutylene, 1-methyl-2-butylbutylene, 1-butyl-2-methylbutylene, 1-methyl-3-butylbutylene, 1-butyl-3-methylbutylene, 1,1-diethylpentylene, 2,2-diethylpentylene, 3,3-diethylpentylene, 1,2-diethylpentylene, 1,3-diethylpentylene, 2,3-diethylpentylene, 2,4-diethylpentylene, 1-methyl-1-ethylhexylene, 2-methyl-2-ethylhexylene, 3-methyl-3-ethylhexylene, 1-methyl-2-ethylhexylene, 1-methyl-3-ethylhexylene, and 2-methyl-3-ethylhexylene.

In some embodiments of the present application, based on the total moles of the repeating unit represented by formula (I), the contents of the repeating unit represented by formula (I-1), the repeating unit represented by formula (I-2), and the repeating unit represented by formula (I-3) are independently from 0 mol % to 100 mol %, such as 1 mol %, 2 mol %, 3 mol %, 4 mol %, 5 mol %, 6 mol %, 7 mol %, 8 mol %, 9 mol %, 10 mol %, 11 mol %, 12 mol %, 13 mol %, 14 mol %, 15 mol %, 16 mol %, 17 mol %, 18 mol %, 19 mol %, 20 mol %, 21 mol %, 22 mol %, 23 mol %, 24 mol %, 25 mol %, 26 mol %, 27 mol %, 28 mol %, 29 mol %, 30 mol %, 31 mol %, 32 mol %, 33 mol %, 34 mol %, 35 mol %, 36 mol %, 37 mol %, 38 mol %, 39 mol %, 40 mol %, 41 mol %, 42 mol %, 43 mol %, 44 mol %, 45 mol %, 46 mol %, 47 mol %, 48 mol %, 49 mol %, 50 mol %, 51 mol %, 52 mol %, 53 mol %, 54 mol %, 55 mol %, 56 mol %, 57 mol %, 58 mol %, 59 mol %, 60 mol %, 61 mol %, 62 mol %, 63 mol %, 64 mol %, 65 mol %, 66 mol %, 67 mol %, 68 mol %, 69 mol %, 70 mol %, 71 mol %, 72 mol %, 73 mol %, 74 mol %, 75 mol %, 76 mol %, 77 mol %, 78 mol %, 79 mol %, 80 mol %, 81 mol %, 82 mol %, 83 mol %, 84 mol %, 85 mol %, 86 mol %, 87 mol %, 88 mol %, 89 mol %, 90 mol %, 91 mol %, 92 mol %, 93 mol %, 94 mol %, 95 mol %, 96 mol %, 97 mol %, 98 mol %, or 99 mol %, or within a range between any two of the values described herein.

More specifically, based on the total moles of the repeating unit represented by formula (I), the content of the repeating unit represented by formula (I-1) can be from 0 mol % to 75 mol %, the content of the repeating unit represented by formula (I-2) can be from 0 mol % to 60 mol %, and the content of the repeating unit represented by formula (I-3) can be from 0 mol % to 90 mol %.

In some embodiments of the present application, the polycarbonate polyol comprises at least one of the repeating unit represented by formula (I-2) and the repeating unit represented by formula (I-3). In some embodiments of the present application, the polycarbonate polyol comprises at least one of the repeating unit represented by formula (I-2) and the repeating unit represented by formula (I-3) and comprises the repeating unit represented by formula (I-1). In some embodiments of the present application, the polycarbonate polyol comprises the repeating unit represented by formula (I-1), the repeating unit represented by formula (I-2) and the repeating unit represented by formula (I-3). When the polycarbonate polyol comprises the repeating unit represented by formula (I-1), the repeating unit represented by formula (I-2) and the repeating unit represented by formula (I-3), based on the total moles of the repeating unit represented by formula (I), the content of the repeating unit represented by formula (I-1) can be from 3 mol % to 75 mol %, the content of the repeating unit represented by formula (I-2) can be from 4 mol % to 60 mol %, and the content of the repeating unit represented by formula (I-3) can be from 6 mol % to 75 mol %, but the present application is not limited thereto.

In some embodiments of the present application, the repeating unit represented by formula (I) comprises the repeating unit represented by formula (I-2), and R₂ in formula (I-2) is 3-methylpentylene (i.e., the repeating unit represented by formula (I-2) is derived from 3-methyl-1,5-pentanediol). Based on the total moles of the repeating unit represented by formula (I), the content of the repeating unit represented by formula (I-2) is more than 0 mol % and 70 mol % or less, and the elastomer prepared from this polycarbonate polyol can be provided with suitable wear resistance and transmittance.

In addition, the polycarbonate polyol of the present application can further comprise a structure of ether glycol. Examples of the structure of ether glycol include but are not limited to the structure derived from the compound selected from the group consisting of polytetramethylene ether glycol, diethylene glycol, triethylene glycol, ethoxylated-1,3-propanediol, propoxylated-1,3-propanediol, ethoxylated-2-methyl-1,3-propanediol, propoxylated-2-methyl-1,3-propanediol, ethoxylated-1,4-butanediol, propoxylated-1,4-butanediol, dibutylene glycol, tributylene glycol, ethoxylated-1,5-pentanediol, propoxylated-1,5-pentanediol, ethoxylated pentyl glycol, propoxylated pentyl glycol, ethoxylated-1,6-hexanediol, and propoxylated-1,6-hexanediol.

1.3. Preparation of Polycarbonate Polyol

1.3.1. Transesterification Reaction of Carbonate and Polyol

The polycarbonate polyol can be obtained by subjecting carbonate and polyol to a transesterification reaction. In some embodiments of the present application, the polycarbonate polyol is obtained by subjecting carbonate and polyol to a transesterification reaction in the presence of a catalyst.

Examples of the catalyst that can be used in the preparation of the polycarbonate polyol include but are not limited to metals, metal salts, metal alkoxides, metal oxides, metal hydrides, metal hydroxides, metal carbonates, metal amides, and metal borates. Examples of the aforementioned metal include but are not limited to lithium, sodium, potassium, magnesium, calcium, strontium, barium, aluminum, titanium, vanadium, chromium, manganese, iron, cobalt, nickel, copper, zinc, gallium, germanium, zirconium, niobium, molybdenum, ruthenium, rhodium, palladium, silver, indium, tin, antimony, tungsten, rhenium, osmium, iridium, platinum, gold, thallium, lead, bismuth, and ytterbium. In terms of the preparation of polycarbonate diol, the metal selected from the following group is preferred: sodium, potassium, magnesium, titanium, zirconium, tin, lead, and ytterbium.

Specific examples of the catalyst include but are not limited to sodium hydroxide, potassium hydroxide, lithium hydroxide, sodium hydrogen carbonate, sodium carbonate, potassium carbonate, lithium carbonate, magnesium hydroxide, calcium hydroxide, strontium hydroxide, barium hydroxide, magnesium hydrogen carbonate, calcium hydrogen carbonate, strontium hydrogen carbonate, barium hydrogen carbonate, magnesium carbonate, calcium carbonate, strontium carbonate, barium carbonate, tetraethyl titanate, tetraisopropyl titanate, tetra-n-butyl titanate, tin(II) chloride, tin(IV) chloride, tin(II) acetate, tin(IV) acetate, dibutyltin dilaurate, dibutyltin oxide, dimethoxy dibutyltin, titanium tetrabutoxide, and zirconium tetrabutoxide.

During the preparation of the polycarbonate polyol of the present application, based on the total weight of the polyol, the content of the catalyst can be from 1 ppm to 5000 ppm, such as 50 ppm, 100 ppm, 150 ppm, 200 ppm, 250 ppm, 300 ppm, 350 ppm, 400 ppm, 450 ppm, 500 ppm, 550 ppm, 600 ppm, 650 ppm, 700 ppm, 750 ppm, 800 ppm, 850 ppm, 900 ppm, 950 ppm, 1000 ppm, 1250 ppm, 1500 ppm, 1750 ppm, 2000 ppm, 2250 ppm, 2500 ppm, 2750 ppm, 3000 ppm, 3250 ppm, 3500 ppm, 3750 ppm, 4000 ppm, 4250 ppm, or 4500 ppm.

The transesterification reaction can be performed under a temperature ranging from 70° C. to 250° C., preferably 90° C. to 230° C., such as 95° C., 100° C., 105° C., 110° C., 115° C., 120° C., 125° C., 130° C., 135° C., 140° C., 145° C., 150° C., 155° C., 160° C., 165° C., 170° C., 175° C., 180° C., 185° C., 190° C., 195° C., 200° C., 205° C., 210° C., 215° C., 220° C., or 225° C.

The transesterification reaction can be performed under the normal pressure (i.e., 760 torr) or a pressure lower than the normal pressure. The pressure lower than the normal pressure can be 750 torr, 700 torr, 650 torr, 600 torr, 550 torr, 500 torr, 450 torr, 400 torr, 350 torr, 300 torr, 250 torr, 200 torr, 150 torr, 100 torr, 95 torr, 90 torr, 85 torr, 80 torr, 75 torr, 70 torr, 65 torr, 60 torr, 55 torr, 50 torr, 45 torr, 40 torr, 35 torr, 30 torr, 25 torr, 20 torr, 15 torr, 10 torr, 5 torr, or 1 torr.

In addition, since light boiling products generated from the reaction must be removed through distillation during the transesterification reaction, an inert gas such as nitrogen, argon, or helium can be aerated into the reaction vessel to facilitate the distillation during the transesterification reaction.

Carbonates that can be used in the preparation of the polycarbonate polyol of the present application are not limited as long as they can perform a transesterification reaction with polyols. Examples of the carbonates include but are not limited to dialkyl carbonates, diaryl carbonates, and alkylene carbonates. Examples of dialkyl carbonates include but are not limited to dimethyl carbonate, diethyl carbonate, di-n-propyl carbonate, diisopropyl carbonate, di-n-butyl carbonate, diisobutyl carbonate, methyl propyl carbonate, methyl butyl carbonate, ethyl butyl carbonate, and propyl butyl carbonate. Examples of diaryl carbonates include but are not limited to diphenyl carbonate, dinaphthyl carbonate, di(n-butylphenyl) carbonate, di(isobutylphenyl) carbonate, di(n-pentylphenyl) carbonate, di(n-hexylphenyl) carbonate, and di(cyclohexylphenyl)carbonate. Examples of alkylene carbonates include but are not limited to ethylene carbonate, propylene carbonate, butylene carbonate, pentylene carbonate, and trimethylene carbonate. In the appended examples, dimethyl carbonate is used.

During the preparation of the polycarbonate polyol of the present application, based on 1 (one) mol of the polyol, the content of carbonates can be from 0.5 mol to 2.5 mol, such as 0.6 mol, 0.7 mol, 0.8 mol, 0.9 mol, 1.0 mol, 1.1 mol, 1.2 mol, 1.3 mol, 1.4 mol, 1.5 mol, 1.6 mol, 1.7 mol, 1.8 mol, 1.9 mol, 2.0 mol, 2.1 mol, 2.2 mol, 2.3 mol, or 2.4 mol, or within a range between any two of the values described herein.

As used herein, polyols are alcohols with at least two hydroxyls (—OH), such as diols, triols, or tetraols. In some embodiments of the present application, diols are used in the preparation of the polycarbonate polyols.

Diols can be generally classified into diols without a side chain, diols with a side chain and cyclic diols according to their structure. Examples of the diols without a side chain include but are not limited to 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, and 1,15-pentadecanediol. Examples of the diols with a side chain include but are not limited to 2-methyl-1,8-octanediol, 2-ethyl-1,6-hexanediol, 2-methyl-1,3-propanediol, 2-ethyl-1,3-propanediol, 2-butyl-1,3-propanediol, 2-methyl-L5-pentanediol, 2-ethyl-L5-pentanediol, 3-methyl-1,5-pentanediol, 2,4-dimethyl-1,5-pentanediol, 2,4-diethyl-1,5-pentanediol, 2-butyl-2-ethyl-1,3-propanediol, 2,2-dimethyl-1,3-propanediol (neopentyl glycol), 2,2-diethyl-1,3-propanediol, 2-propyl-2-methyl-1,3-propanediol, 2,2-dimethyl-1, 4-butanediol, 2,2-diethyl-1,4-butanediol, 2,2-dimethyl-1, 5-pentanediol, and 2,2-diethyl-1,5-pentanediol. Examples of the cyclic diols include but are not limited to 1,4-cyclohexanediol, tricyclodecane dimethanol, and 2,2-bis(4-hydroxylcyclohexyl)-propane.

Examples of the triols include but are not limited to glycerol, trimethylolethane, trimethylolpropane, and hexanetriol. Examples of the tetraols include but are not limited to pentaerythritol.

In the polycarbonate polyol of the present application, the R moiety in the structure of the repeating unit represented by formula (I), the R₁ moiety in the structure of the repeating unit represented by formula (I-1), the R₂ moiety in the structure of the repeating unit represented by formula (I-2), and the R₃ moiety in the structure of the repeating unit represented by formula (I-3) are derived from diols. In some embodiments of the present application, the repeating unit represented by formula (I-1) can be derived from one or more compounds selected from the group consisting of 1,3-propanediol, 1,4-butanediol, 1,5-pentanediol, 1,6-hexanediol, 1,7-heptanediol, and 1,8-octanediol. The repeating unit represented by formula (I-2) can be derived from one or more compounds selected from the group consisting of 2-methyl-1,3-propanediol, 2-ethyl-1,3-propanediol, 2-butyl-1,3-propanediol, 2-methyl-1,5-pentanediol, 2-ethyl-1,5-pentanediol, 2-ethyl-1,6-hexanediol, and 3-methyl-1,5-pentanediol. The repeating unit represented by formula (I-3) can be derived from one or more compounds selected from the group consisting of 2,2-dimethyl-1,3-propanediol (neopentyl glycol), 2,2-diethyl-1,3-propanediol, 2-propyl-2-methyl-1,3-propanediol, 2-butyl-2-ethyl-1,3-propanediol, 2,2-dimethyl-1,4-butanediol, 2,2-diethyl-1,4-butanediol, 2,2-dimethyl-1, 5-pentanediol, and 2,2-diethyl-1,5-pentanediol.

1.3.2. Other Preparation Methods

In addition to the aforementioned transesterification reaction, the polycarbonate polyol of the present application can also be prepared using other preparation methods. The other preparation methods include but are not limited to carbon dioxide-epoxides alternative copolymerization. In brief, the implementing manner of carbon dioxide-epoxides alternative copolymerization includes that one or more alkene oxides are added to one or more H-functional starting substances in the presence of a catalyst to prepare polycarbonate polyols. Examples of the catalyst include but are not limited to double metal cyanide catalyst and metal complex catalysts based on the metals zinc and/or cobalt. The details of carbon dioxide-epoxides alternative copolymerization will not be described in detail here, given that it is not a key point of the present application and can be easily performed by persons having ordinary skill in the art based on the disclosure of the subject specification and their general knowledge.

### 2. ELASTOMER PRECURSOR COMPOSITION AND ELASTOMER

The polycarbonate polyol of the present application can be used to prepare elastomers. Thus, the present application also provides an elastomer precursor composition and an elastomer prepared from the elastomer precursor composition, wherein the elastomer precursor composition comprises the aforementioned polycarbonate polyol and an optional chain extending agent.

Examples of the elastomer include but are not limited to polyurethane and polyesters (e.g., thermoplastic polyester elastomers). The preparation of polyurethane is illustrated in the appended examples as an exemplary embodiment. As can be seen from the appended examples, the polyurethane can be prepared by reacting the polycarbonate polyol of the present application with polyisocyanate and an optional chain extending agent. The polyurethane prepared from the polycarbonate polyol of the present application can be provided with excellent mechanical strength, wear resistance and transmittance. The prepared polyurethane can be used widely in the fields of automotive products, food packaging, medical equipment, sporting equipment, electronic product, building materials, furniture, and the like.

### 3. EXAMPLE

3.1. Test Methods

The present application is further illustrated by the embodiments hereinafter, wherein the testing instruments and methods are as follows:

[¹H-NMR Spectrum Measurement]

Polycarbonate polyol is dissolved in deuterated chloroform (CDCl₃, available from Aldrich) to obtain a solution with a concentration of 6 g/ml. Tetramethylsilane is added into the solution as a reference substance for chemical shift referencing, and the solution is measured by using a nuclear magnetic resonance spectrometer (model: ECZ600R, available from JEOL) to obtain the ¹H-NMR spectrum. The measuring conditions are as follows: a resonance frequency of 600 MHZ, a pulse width of 45°, an acquisition time of 1 (one) second, a number of scan of 128, and a signal of tetramethylsilane being set to 0 ppm.

[100% Modulus and Tensile Strength Test]

A thin film of polyurethane prepared from the polycarbonate polyol is cut into a specimen with a length of 100 mm, a width of 10 mm and a thickness of 0.1 mm. The specimen of polyurethane is tested using a universal tensile machine in accordance with JIS K6301 to obtain 100% modulus and tensile strength. The units of 100% modulus and tensile strength are both MPa.

[Wear Resistance Test]

A thin film of polyurethane prepared from the polycarbonate polyol is cut into a specimen with a length of 100 mm, a width of 100 mm and a thickness of 3 mm, and the specimen is then weighed. Next, the specimen of polyurethane is tested using a rotary abrasion tester (model: 5135, available from Taber Industries) in accordance with ASTM D4060 to obtain wear resistance. The test conditions are as follows: use of a CS-10 Calibrase abrasive wheel, a rotation speed of 62 rpm, and 500 revolutions. The specimen of polyurethane is weighed once again after the test to calculate the weight loss of polyurethane. The wear resistance are evaluated as follows: a weight loss of ≤2 mg means that the wear resistance is good, and the result is recorded as “A”; a weight loss of >2 mg and ≤4 mg means that the wear resistance is acceptable, and the result is recorded as “B”; and a weight loss of >4 mg means that the wear resistance is bad, and the result is recorded as “C”.

[Transmittance Test]

A thin film of polyurethane prepared from the polycarbonate polyol is cut into a specimen with a length of 50 mm, a width of 50 mm and a thickness of 0.2 mm. The specimen of polyurethane is then tested using a hazemeter (model: haze-gard i 4775, available from BYK-Gardner) in accordance with ASTM D 1003-13 to obtain transmittance. The transmittance is evaluated as follows: a measured transmittance of ≥90% means that the transmittance is good, and the result is recorded as “A”; a measured transmittance of ≥80% and <90% means that that the transmittance is acceptable, and the result is recorded as “B”; and a measured transmittance of <80% means that the transmittance is bad, and the result is recorded as “C”.

3.2. Preparation of Polycarbonate Diol

### Synthesis Example 1

The following raw materials were added into a glass round-bottom flask with a rectifying column, a stirrer, a thermometer and a nitrogen inlet pipe: 1004 g of dimethyl carbonate, 556 g of 1,4-butanediol, 251 g of 2-butyl-2-ethyl-1,3-propanediol, 58 g of 3-methyl-1,5-pentanediol, and 0.1 g of titanium tetrabutoxide (catalyst). The raw materials were then stirred under normal pressure and nitrogen aeration such that a transesterification reaction was performed for 8 hours while a mixture of methanol and dimethyl carbonate was simultaneously removed by distillation. During the transesterification reaction, the temperature of reaction was slowly raised from 95° C. to 150° C., and the constitution of the distillate was modified to an azeotropic constitution of methanol and dimethyl carbonate. Afterwards, the pressure was slowly reduced to 100 torr, and the transesterification reaction was further performed for 1 (one) hour under stirring and 150° C. while the mixture of methanol and dimethyl carbonate was simultaneously removed by distillation. Next, the pressure was further reduced to 10 torr to react for 5 hours. After the reaction was completed, the product was cooled to room temperature to obtain polycarbonate diol. The polycarbonate diol of Synthesis Example 1 had a weight of 1055 g and a hydroxyl value of 54.19 mgKOH/g.

### Synthesis Example 2

The preparation procedures of Synthesis Example 1 were repeated to prepare the polycarbonate diol of Synthesis Example 2, except that the following raw materials were used instead: 829 g of dimethyl carbonate, 312 g of 1,4-butanediol, 477 g of 2-butyl-2-ethyl-1,3-propanediol, 57 g of 3-methyl-1,5-pentanediol, and 0.24 g of titanium tetrabutoxide (catalyst). The polycarbonate diol of Synthesis Example 2 had a weight of 1032 g and a hydroxyl value of 54.77 mgKOH/g.

### Synthesis Example 3

The preparation procedures of Synthesis Example 1 were repeated to prepare the polycarbonate diol of Synthesis Example 3, except that the following raw materials were used instead: 745 g of dimethyl carbonate, 120 g of 1,4-butanediol, 759 g of 2-butyl-2-ethyl-1,3-propanediol, 30 g of 3-methyl-1,5-pentanediol, and 0.15 g of titanium tetrabutoxide (catalyst). The polycarbonate diol of Synthesis Example 3 had a weight of 1108 g and a hydroxyl value of 55.75 mgKOH/g.

### Synthesis Example 4

The preparation procedures of Synthesis Example 1 were repeated to prepare the polycarbonate diol of Synthesis Example 4, except that the following raw materials were used instead: 1046 g of dimethyl carbonate, 451 g of 2-methyl-1,3-propanediol, 267 g of 1,4-butanediol, 81 g of 2-butyl-2-ethyl-1,3-propanediol, and 0.14 g of titanium tetrabutoxide (catalyst). The polycarbonate diol of Synthesis Example 4 had a weight of 975 g and a hydroxyl value of 55.59 mgKOH/g.

### Synthesis Example 5

The preparation procedures of Synthesis Example 1 were repeated to prepare the polycarbonate diol of Synthesis Example 5, except that the following raw materials were used instead: 1155 g of dimethyl carbonate, 101 g of 2-methyl-1,3-propanediol, 692 g of 1,4-butanediol, 90 g of 2-butyl-2-ethyl-1,3-propanediol, and 0.19 g of titanium tetrabutoxide (catalyst). The polycarbonate diol of Synthesis Example 5 had a weight of 1077 g and a hydroxyl value of 57.18 mgKOH/g.

### Synthesis Example 6

The preparation procedures of Synthesis Example 1 were repeated to prepare the polycarbonate diol of Synthesis Example 6, except that the following raw materials were used instead: 1120 g of dimethyl carbonate, 50 g of 2-methyl-1,3-propanediol, 390 g of 1,4-butanediol, 451 g of neopentyl glycol, and 0.19 g of titanium tetrabutoxide (catalyst). The polycarbonate diol of Synthesis Example 6 had a weight of 1086 g and a hydroxyl value of 54.41 mgKOH/g.

### Synthesis Example 7

The preparation procedures of Synthesis Example 1 were repeated to prepare the polycarbonate diol of Synthesis Example 7, except that the following raw materials were used instead: 1124 g of dimethyl carbonate, 110 g of 2-methyl-1,3-propanediol, 367 g of 1,6-hexanediol, 519 g of neopentyl glycol, and 0.18 g of titanium tetrabutoxide (catalyst). The polycarbonate diol of Synthesis Example 7 had a weight of 1215 g and a hydroxyl value of 57.01 mgKOH/g.

### Synthesis Example 8

The preparation procedures of Synthesis Example 1 were repeated to prepare the polycarbonate diol of Synthesis Example 8, except that the following raw materials were used instead: 734 g of dimethyl carbonate, 185 g of 1,6-hexanediol, 713 g of 2-butyl-2-ethyl-1,3-propanediol, 30 g of 3-methyl-1,5-pentanediol, and 0.31 g of titanium tetrabutoxide (catalyst). The polycarbonate diol of Synthesis Example 8 had a weight of 1132 g and a hydroxyl value of 54.98 mgKOH/g.

### Synthesis Example 9

The preparation procedures of Synthesis Example 1 were repeated to prepare the polycarbonate diol of Synthesis Example 9, except that the following raw materials were used instead: 695 g of dimethyl carbonate, 48 g of 2-methyl-1,3-propanediol, 32 g of 1,4-butanediol, 809 g of 2-butyl-2-ethyl-1,3-propanediol, and 0.24 g of titanium tetrabutoxide (catalyst). The polycarbonate diol of Synthesis Example 9 had a weight of 1084 g and a hydroxyl value of 55.16 mgKOH/g.

### Synthesis Example 10

The preparation procedures of Synthesis Example 1 were repeated to prepare the polycarbonate diol of Synthesis Example 10, except that the following raw materials were used instead: 618 g of dimethyl carbonate, 609 g of 2-butyl-2-ethyl-1,3-propanediol, 184 g of 3-methyl-1,5-pentanediol, and 0.23 g of titanium tetrabutoxide (catalyst). The polycarbonate diol of Synthesis Example 10 had a weight of 967 g and a hydroxyl value of 54.42 mgKOH/g.

### Synthesis Example 11

The preparation procedures of Synthesis Example 1 were repeated to prepare the polycarbonate diol of Synthesis Example 11, except that the following raw materials were used instead: 720 g of dimethyl carbonate, 17 g of 1,4-butanediol, 871 g of 2-butyl-2-ethyl-1,3-propanediol, 74 g of 3-methyl-1,5-pentanediol, and 0.26 g of titanium tetrabutoxide (catalyst). The polycarbonate diol of Synthesis Example 11 had a weight of 1173 g and a hydroxyl value of 54.88 mgKOH/g.

### Comparative Synthesis Example 1

0.15 g of titanium tetrabutoxide (catalyst) and the following reactants were added into a glass round-bottom flask with a rectifying column, a stirrer, a thermometer and a nitrogen inlet pipe: 830 g of dimethyl carbonate, and 836 g of 1,6-hexanediol. Then, the reactants were stirred under normal pressure and nitrogen aeration such that a transesterification reaction was performed for 8 hours while a mixture of methanol and dimethyl carbonate was simultaneously removed by distillation. During the transesterification reaction, the temperature of reaction was slowly raised from 95° C. to 180° C., and the constitution of the distillate was modified to an azeotropic constitution of methanol and dimethyl carbonate. Afterwards, the pressure was slowly reduced to 100 torr, and the transesterification reaction was further performed for 1 (one) hour by stirring at 180° C. while the mixture of methanol and dimethyl carbonate was simultaneously removed by distillation. Next, the pressure was further reduced to 10 torr to react for 5 hours. After the reaction was completed, the product was cooled to room temperature to obtain polycarbonate diol. The polycarbonate diol of Comparative Synthesis Example 1 has a weight of 1022 g and a hydroxyl value of 56.48 mgKOH/g.

### Comparative Synthesis Example 2

The preparation procedures of Synthesis Example 1 were repeated to prepare the polycarbonate diol of Comparative Synthesis Example 2, except that the following raw materials were used instead: 1113 g of dimethyl carbonate, 813 g of 1,4-butanediol, and 0.20 g of titanium tetrabutoxide (catalyst). The polycarbonate diol of Comparative Synthesis Example 2 had a weight of 991 g and a hydroxyl value of 57.32 mgKOH/g.

### Comparative Synthesis Example 3

The preparation procedures of Synthesis Example 1 were repeated to prepare the polycarbonate diol of Comparative Synthesis Example 3, except that the following raw materials were used instead: 660 g of dimethyl carbonate, 904 g of 2-butyl-2-ethyl-1,3-propanediol, and 0.19 g of titanium tetrabutoxide (catalyst). The polycarbonate diol of Comparative Synthesis Example 3 had a weight of 1102 g and a hydroxyl value of 55.47 mgKOH/g.

### Comparative Synthesis Example 4

The preparation procedures of Synthesis Example 1 were repeated to prepare the polycarbonate diol of Comparative Synthesis Example 4, except that the following raw materials were used instead: 681 g of dimethyl carbonate, 21 g of 1,4-butanediol, 194 g of neopentyl glycol, 596 g of 2-butyl-2-ethyl-1,3-propanediol, and 0.18 g of titanium tetrabutoxide (catalyst). The polycarbonate diol of Comparative Synthesis Example 4 had a weight of 989 g and a hydroxyl value of 54.93 mgKOH/g.

### Comparative Synthesis Example 5

The preparation procedures of Synthesis Example 1 were repeated to prepare the polycarbonate diol of Comparative Synthesis Example 5, except that the following raw materials were used instead: 827 g of dimethyl carbonate, 355 g of 1,4-butanediol, 476 g of 2-butyl-2-ethyl-1,3-propanediol, and 0.24 g of titanium tetrabutoxide (catalyst). The polycarbonate diol of Comparative Synthesis Example 5 had a weight of 1013 g and a hydroxyl value of 55.53 mgKOH/g.

### Comparative Synthesis Example 6

The following raw materials were added into a glass round-bottom flask with a rectifying column, a stirrer, a thermometer and a nitrogen inlet pipe: 950 g of dimethyl carbonate, 920 g of 1,6-hexanediol, and 0.12 g of titanium tetrabutoxide (catalyst). Then, the raw materials were stirred under normal pressure and nitrogen aeration such that a transesterification reaction was performed for 8 hours while a mixture of methanol and dimethyl carbonate was simultaneously removed by distillation. During the transesterification reaction, the temperature of reaction was slowly raised from 95° C. to 150° C., and the constitution of the distillate was modified to an azeotropic constitution of methanol and dimethyl carbonate. Afterwards, the pressure was slowly reduced to 100 torr, and the transesterification reaction was further performed for 1 (one) hour under stirring and 150° C. while the mixture of methanol and dimethyl carbonate was simultaneously removed by distillation. Next, the pressure was further reduced to 10 torr to react for 5 hours. After the reaction was completed, the product was cooled to room temperature to obtain polycarbonate diol. The poly carbonate diol of Comparative Synthesis Example 6 has a weight of 1122 g and a hydroxyl value of 52.41 mgKOH/g.

The ¹H-NMR spectrums of the polycarbonate diols of Synthesis Examples 1 to 11 and Comparative Synthesis Examples 1 to 6 were evaluated according to the aforementioned test methods. The ratio of the integral value D to the integral value A (D/A) and the ratio of the integral value F multiplied by 1000 to the integral value A ((F×10³)/A) were calculated, and the results tabulated in Table 1. In Table 1, the ratio of the integral value F to the integral value A of Synthesis Example 8 is shown by “N.D”, indicating that the instrument could not detect any signal from 3.70 ppm to 3.85 ppm and thus the integral value F could not be calculated.

TABLE 1
Properties of polycarbonate diols of Synthesis Examples 1
to 11 and Comparative Synthesis Examples 1 to 6

| Property | | D/A | (F × 10³)/A |
|---|---|---|---|
| Synthesis | 1 | 0.34 | 0.21 |
| Example | 2 | 0.72 | 3.26 |
| | 3 | 1.21 | 1.53 |
| | 4 | 0.55 | 2.07 |
| | 5 | 0.18 | 1.24 |
| | 6 | 0.77 | 0.81 |
| | 7 | 0.93 | 5.31 |
| | 8 | 1.08 | N.D. |
| | 9 | 1.41 | 9.63 |
| | 10 | 1.34 | 1.64 |
| | 11 | 1.45 | 4.12 |
| Comparative | 1 | 0.01 | 2.15 |
| Synthesis | 2 | 0.02 | 1.36 |
| Example | 3 | 1.57 | 5.47 |
| | 4 | 1.50 | 3.15 |
| | 5 | 0.67 | 15.17 |
| | 6 | 0.01 | 17.54 |

3.3. Preparation of Polyurethane

The polycarbonate diols of Synthesis Examples 1 to 11 and Comparative Synthesis Examples 1 to 6 were used to prepare the polyurethanes of Examples 1 to 11 and Comparative Examples 1 to 6, respectively. The preparing methods are described below. First, 0.1 mol of polycarbonate diol was heated to 70° C. in advance. Next, 0.1 mol of the preheated polycarbonate diol, 0.2 mol of 1,4-butanediol, 1 (one) drop of dibutyltin dilaurate, and 600 g of dimethyl formamide (solvent) were added into a separable flask, and stirred evenly at 55° C. such that each component dissolved in the solvent. Then, 0.3 mol of methylene diphenyl diisocyanate (MDI) was added into the flask, and reaction was performed at 80° C. for 8 hours to obtain a polyurethane solution with a solid content of 30%. The polyurethane solution was coated onto a polyethylene film by means of a doctor blade, and then dried at 80° C. to obtain a polyurethane film.

The properties of the polyurethane of Examples 1 to 11 and Comparative Examples 1 to 6, including 100% modulus, tensile strength, wear resistance, and transmittance, were evaluated according to the aforementioned test methods, with the results listed in Table 2.

TABLE 2
Property of polyurethane of Examples 1 to 11 and
Comparative Examples 1 to 6

| | | 100% | Tensile | | |
|---|---|---|---|---|---|
| | | modulus | strength | Wear | |
| Unit | | MPa | MPa | resistance | Transmittance |
| Example | 1 | 9.40 | 53.2 | B | B |
| | 2 | 9.6 | 40.5 | A | A |
| | 3 | 11.4 | 37.6 | A | A |
| | 4 | 10.8 | 39.4 | A | A |
| | 5 | 9.5 | 50.6 | B | B |
| | 6 | 10.3 | 42.2 | A | A |
| | 7 | 8.4 | 45.3 | B | A |
| | 8 | 9.6 | 46.6 | A | A |
| | 9 | 10.7 | 38.7 | A | A |
| | 10 | 8.9 | 45.5 | B | A |
| | 11 | 11.1 | 39.2 | A | A |
| Comparative | 1 | 6.3 | 57.4 | C | C |
| Example | 2 | 9.2 | 52.3 | B | C |
| | 3 | 10.9 | 29.8 | B | A |
| | 4 | 11.2 | 30.3 | B | A |
| | 5 | 11.2 | 25.1 | A | A |
| | 6 | 5.1 | 32.3 | C | C |

As shown in Table 2, each of the polyurethanes prepared from the polycarbonate diol of the present application is provided with excellent mechanical strength, good wear resistance and transmittance of at least 80%. Specifically, Examples 1 to 11 indicate that, as long as the ratio of the integral value D to the integral value A (D/A) obtained from the ¹H-NMR spectrum of the polycarbonate diol falls within the designated range, regardless of the type of diols, the prepared polyurethane can have excellent mechanical strength, good wear resistance and transmittance of at least 80%.

By contrast, as shown in Table 2, the polyurethanes prepared by using the polycarbonate diols other than the polycarbonate diol of the present application do not simultaneously have excellent mechanical strength, good wear resistance and transmittance of at least 80%. Comparative Examples 1, 2, and 6 indicate that, when the ratio of the integral value D to the integral value A (D/A) obtained from the ¹H-NMR spectrum of the polycarbonate diol is lower than the designated range, the prepared polyurethanes have transmittance less than 80% and poor wear resistance. Comparative Examples 3 ad 4 show that, when the ratio of the integral value D to the integral value A (D/A) obtained from the ¹H-NMR spectrum of the poly carbonate diol is higher than the designated range, the prepared polyurethanes therefrom have poor tensile strength. In addition, Comparative Examples 5 and 6 show that, when the ratio of the integral value F to the integral value A (F/A) obtained from the ¹H-NMR spectrum of the polycarbonate diol is higher than the designated value, the prepared polyurethanes have poor tensile strength.

The above examples are used to illustrate the principle and efficacy of the present application and show the inventive features thereof but are not used to limit the scope of the present application. People skilled in this field may proceed with a variety of modifications and replacements based on the disclosures and suggestions of the invention as described without departing from the principle and spirit thereof. Therefore, the scope of protection of the present application is that as defined in the claims as appended.

What is claimed is:

1. A polycarbonate polyol, which comprises a repeating unit represented by the following formula (I) and terminal hydroxyls: 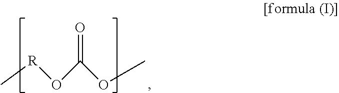
in formula (I), R is a substituted or unsubstituted C₂-C₂₀ divalent aliphatic hydrocarbyl,
wherein the ¹H-NMR spectrum of the polycarbonate polyol has an integral value A of signals from 4.00 ppm to 4.50 ppm and an integral value D of signals from 0.90 ppm to 1.10 ppm, the ratio of D to A (D/A) ranges from 0.03 to 1.45, and the ¹H-NMR spectrum is measured by using deuterated chloroform as a solvent and tetramethylsilane as a reference substance.

2. The polycarbonate polyol of claim 1, wherein the ¹H-NMR spectrum is obtained by using a nuclear magnetic resonance spectrometer to measure the polycarbonate polyol under the following conditions: a resonance frequency of 600 MHZ, a pulse width of 45°, an acquisition time of 1 (one) second, a number of scan of 128, and a signal of tetramethylsilane being set to 0 ppm.

3. The polycarbonate polyol of claim 1, wherein the ratio of D to A (D/A) ranges from 0.10 to 1.40.

4. The polycarbonate polyol of claim 1, wherein the ¹H-NMR spectrum of the polycarbonate polyol has an integral value F of signals from 3.70 ppm to 3.85 ppm, and the ratio of F to A (F/A) is not larger than 0.01.

5. The polycarbonate polyol of claim 1, wherein the repeating unit represented by formula (I) comprises at least one of a repeating unit represented by the following formula (I-1), a repeating unit represented by the following formula (I-2), and a repeating unit represented by the following formula (I-3), 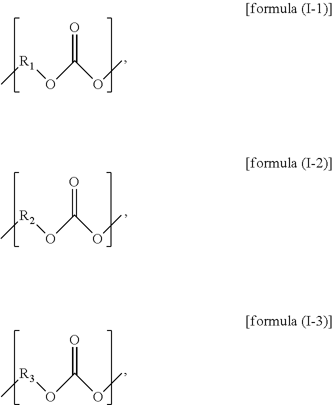
wherein, R₁ is a C₂-C₁₂ linear divalent aliphatic hydrocarbyl, R₂ is a C₄-C₁₂ divalent aliphatic hydrocarbyl with a tertiary carbon atom and without a quaternary carbon atom, and R₃ is C₅-C₁₂ divalent aliphatic hydrocarbyl with a quaternary carbon atom.

6. The polycarbonate polyol of claim 2, wherein the repeating unit represented by formula (I) comprises at least one of a repeating unit represented by the following formula (I-1), a repeating unit represented by the following formula (I-2), and a repeating unit represented by the following formula (I-3), 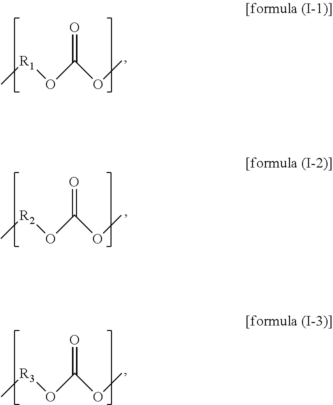
wherein, R₁ is a C₂-C₁₂ linear divalent aliphatic hydrocarbyl, R₂ is a C₄-C₁₂ divalent aliphatic hydrocarbyl with a tertiary carbon atom and without a quaternary carbon atom, and R₃ is C₅-C₁₂ divalent aliphatic hydrocarbyl with a quaternary carbon atom.

7. The polycarbonate polyol of claim 3, wherein the repeating unit represented by formula (I) comprises at least one of a repeating unit represented by the following formula (I-1), a repeating unit represented by the following formula (I-2), and a repeating unit represented by the following formula (I-3), 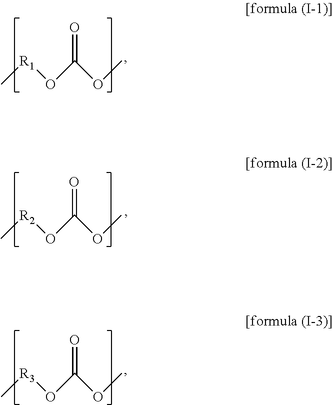
wherein, R₁ is a C₂-C₁₂ linear divalent aliphatic hydrocarbyl, R₂ is a C₄-C₁₂ divalent aliphatic hydrocarbyl with a tertiary carbon atom and without a quaternary carbon atom, and R₃ is C₅-C₁₂ divalent aliphatic hydrocarbyl with a quaternary carbon atom.

8. The polycarbonate polyol of claim 4, wherein the repeating unit represented by formula (I) comprises at least one of a repeating unit represented by the following formula (I-1), a repeating unit represented by the following formula (I-2), and a repeating unit represented by the following formula (I-3), 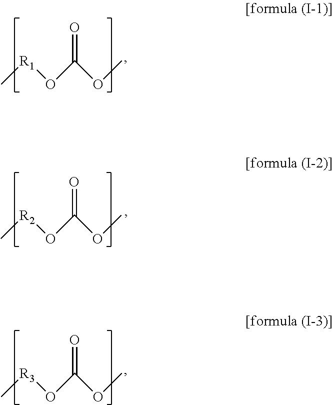
wherein, R₁ is a C₂-C₁₂ linear divalent aliphatic hydrocarbyl, R₂ is a C₄-C₁₂ divalent aliphatic hydrocarbyl with a tertiary carbon atom and without a quaternary carbon atom, and R₃ is C₅-C₁₂ divalent aliphatic hydrocarbyl with a quaternary carbon atom.

9. The polycarbonate polyol of claim 5, which comprises at least one of the repeating unit represented by formula (1-2) and the repeating unit represented by formula (I-3).

10. The polycarbonate polyol of claim 6, which comprises at least one of the repeating unit represented by formula (1-2) and the repeating unit represented by formula (I-3).

11. The polycarbonate polyol of claim 7, which comprises at least one of the repeating unit represented by formula (1-2) and the repeating unit represented by formula (I-3).

12. The polycarbonate polyol of claim 8, which comprises at least one of the repeating unit represented by formula (I-2) and the repeating unit represented by formula (I-3).

13. The polycarbonate polyol of claim 9, which further comprises the repeating unit represented by formula (I-1).

14. The polycarbonate polyol of claim 10, which further comprises the repeating unit represented by formula (I-1).

15. The polycarbonate polyol of claim 11, which further comprises the repeating unit represented by formula (I-1).

16. The polycarbonate polyol of claim 12, which further comprises the repeating unit represented by formula (I-1).

17. The polycarbonate polyol of claim 5, wherein R₁ is a C₃-C₁₀ linear divalent aliphatic hydrocarbyl, R₂ is a C₄-C₁₀ divalent aliphatic hydrocarbyl with a tertiary carbon atom and without a quaternary carbon atom, and R₃ is C₅-C₁₀ divalent aliphatic hydrocarbyl with a quaternary carbon atom.

18. The polycarbonate polyol of claim 6, wherein R₁ is a C₃-C₁₀ linear divalent aliphatic hydrocarbyl, R₂ is a C₄-C₁₀ divalent aliphatic hydrocarbyl with a tertiary carbon atom and without a quaternary carbon atom, and R₃ is C₅-C₁₀ divalent aliphatic hydrocarbyl with a quaternary carbon atom.

19. An elastomer precursor composition, which comprises the polycarbonate polyol of claim 1, and an optional chain extending agent.

20. An elastomer, which is prepared from the elastomer precursor composition of claim 19.
